(19) United States
(12) Patent Application Publication
(10) Pub. No.: US 2013/0191197 A1
(43) Pub. Date: Jul. 25, 2013

(54) CUSTOMER REWARDS AND FEEDBACK SYSTEMS AND RELATED METHODS

(71) Applicants: Michael Hamrick, Hixson, TX (US); Stephen Rosenberg, Athens, GA (US)

(72) Inventors: Michael Hamrick, Hixson, TX (US); Stephen Rosenberg, Athens, GA (US)

(21) Appl. No.: 13/746,357

(22) Filed: Jan. 22, 2013

Related U.S. Application Data
(60) Provisional application No. 61/588,949, filed on Jan. 20, 2012.

(51) Int. Cl. G06Q 30/02

(52) U.S. Cl. CPC G06Q 30/0217
USPC 705/14.19

(57) ABSTRACT

A system for providing offer codes to customers, the offer codes being associated with rewards in exchange for completion of feedback surveys for a particular business following a transaction between the customer and the particular business. In various embodiments, the system is configured to provide a customer with an offer code for a particular business. In response to receiving confirmation that the customer has completed a qualifying transaction under the offer code with the particular business, the system, in various embodiments, is configured to notify the customer of an available feedback survey. In response to receiving the completed feedback survey from the customer, the system may be configured to provide compensation to the customer, which may be based at least in part on terms and conditions associated with the offer code.

### CROSS REFERENCE TO RELATED APPLICATION

This claims the benefit of priority under 35 U.S.C. §119(e) to U.S. Provisional Patent Application No. 61/588,949, filed Jan. 20, 2012, entitled, “Customer Rewards and Feedback Systems and Related Methods,” which is incorporated herein by reference in its entirety.

### BACKGROUND

Companies may desire to receive feedback from customers concerning their business and may also desire to entice new customers to patronize their business. There is currently a need for improved systems to allow companies to collect customer feedback data and solicit new customers.

### SUMMARY

A computer system, according to particular embodiments, comprises at least one processor. In various embodiments, the computer system may be configured for receiving a request for an offer code associated with a particular business from a customer. In response to receiving the request, the system may be configured to provide the offer code to the customer. In particular embodiments, the system may be configured to receive confirmation of a completed qualifying transaction under the offer code between the customer and the particular business, in response to which the system is configured to notify the customer of an available feedback survey. In particular embodiments, in response to receiving a completed version of the feedback survey, the system is configured to provide compensation to the customer.

A non-transitory computer-readable medium according to particular embodiments stores computer-executable instructions for: (A) receiving from a customer, a request for an offer code associated with a particular business, the offer code comprising an offer associated with one or more goods or services offered by the particular business; (B) providing the offer code to the customer; (C) receiving confirmation of a purchase of the one or more goods or services by the customer from the particular business, the one or more goods or services having a particular price; (D) notifying the customer of an available feedback survey for the particular business; (E) receiving a completed version of the feedback survey from the customer; and (F) in response to receiving the completed version of the feedback survey, providing compensation to the customer.

A computer system, according to particular embodiments, comprises at least one processor. In various embodiments, the computer system may be configured for receiving, from a customer, a request for an offer code associated with a particular business. In various embodiments, the offer code is associated with an offer for compensation in exchange for completion of one or more feedback surveys by the customer. In particular embodiments, the system may be further configured for providing the offer code to the customer and receiving confirmation of a transaction between the customer and the particular business. In various embodiments, the transaction may include: (1) a purchase by the customer of one or more goods and/or services from the particular business, the purchase having a price that does not depend on the offer; and (2) provision of the offer code by the customer to the particular business. In various embodiments, the system, in response to receiving the confirmation, is configured to provide one or more feedback surveys to the customer. In response to receiving confirmation of receipt of completed versions of the one or more feedback surveys, the system may be configured to provide compensation to the customer.

### BRIEF DESCRIPTION OF THE DRAWINGS

In the description below, reference will now be made to the accompanying drawings, which are not necessarily drawn to scale, and wherein:

FIG. 1 shows a block diagram of a Customer Feedback Reward System according to one embodiment.

FIG. 2 shows a block diagram of a computer, such as the Customer Feedback Reward Server of FIG. 1.

FIG. 3 depicts a flowchart that generally illustrates a Customer Feedback Reward Module according to a particular embodiment.

FIG. 4 shows an exemplary user interface for a Customer Feedback System according to a particular embodiment.

FIG. 5 shows an exemplary user interface for a Customer Feedback System according to another embodiment.

FIG. 6 shows an exemplary user interface for a Customer Feedback System according to yet another embodiment.

### DETAILED DESCRIPTION OF VARIOUS EMBODIMENTS

Various embodiments now will be described with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A Customer Feedback Reward System, according to particular embodiments, is configured to provide rewards to customers who patronize a particular business and complete a feedback survey about their experience at the particular business. In various embodiments, the system is configured to allow customers to opt into a reward offer that a particular company or business has offered. The system may be configured to receive confirmation that the customer has redeemed the reward offer as part of a qualifying transaction with the particular business. At the time of the qualifying transaction, the customer may pay full price for whatever goods and/or services the customer has purchased. In particular embodiments, the system, in response to determining that the customer has redeemed the reward offer, is configured to provide a feedback survey to the customer regarding the customer's experience with the particular company or business for the customer to complete. Once the customer has completed the feedback survey and the system has received the completed feedback survey, the system may be adapted to provide the customer with compensation (e.g., such as cash-back payments, reward points that the customer can redeem at one or more businesses, or any other suitable form of compensation). In various embodiments, the compensation may be based at least in part on terms and conditions associated with the reward offer. Further description of various aspects of the Customer Feedback Reward System is included below.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Exemplary System Architecture

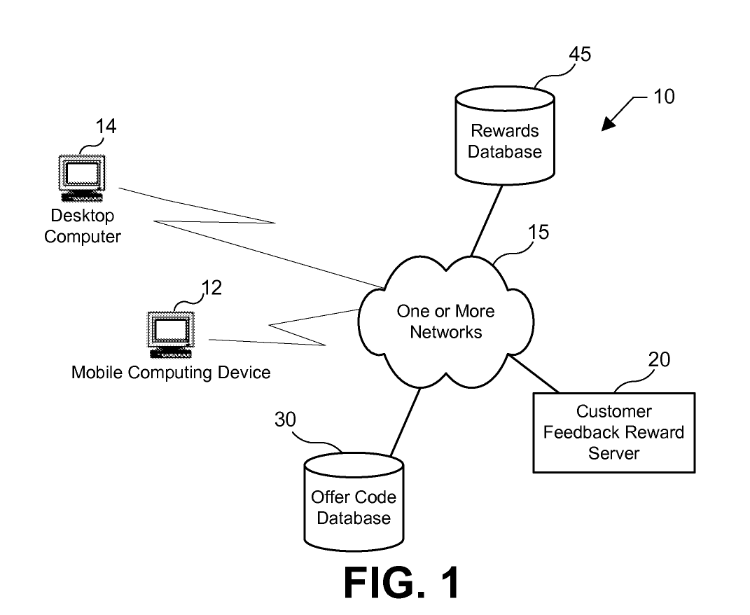

FIG. 1 shows a block diagram of a Customer Feedback Reward System 10 according to a particular embodiment of the present invention. As may be understood from this figure, the Customer Feedback Reward System 10, according to particular embodiments, may include one or more Desktop Computers 14, one or more Mobile Computing Devices 12 (e.g., such as a smart phone, tablet computer, or laptop computer), one or more computer networks 15, a Customer Feedback Reward Server 20, an Offer Code Database 30 (e.g., a database of available offers, which may, for example, include offers provided by various businesses), and a Rewards Database 45 (e.g., a database of available customer rewards, which may, for example, include rewards made available by the various businesses that are also providing offers). The one or more computer networks 15 facilitate communication between the one or more Desktop Computers 14, one or more Mobile Computing Devices 12, Customer Feedback Reward Server 20, Offer Code Database 30, and Rewards Database 45. These one or more computer networks 15 may include any of a variety of types of computer networks such as the Internet, a private intranet, a public switch telephone network (PSTN), or any other type of network known in the art. In certain variations of the embodiment shown in FIG. 1, both the communication link between the one or more Desktop Computers 14, one or more Mobile Computing Devices 12, Customer Feedback Reward Server 20, Offer Code Database 30, and Rewards Database 45 are implemented via the Internet using Internet protocol (IP). The communication link between the Customer Feedback Reward Server 20 and the Rewards Database 45 may be, for example, implemented via a Local Area Network (LAN).

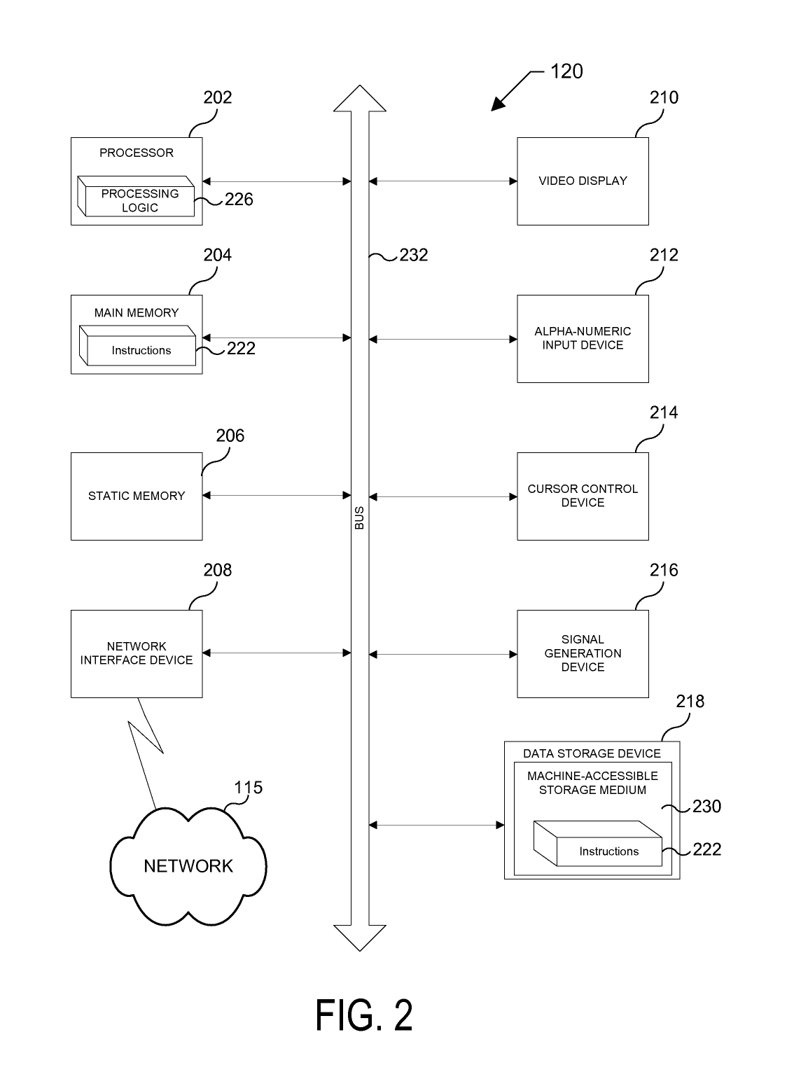

FIG. 2 illustrates a diagrammatic representation of a computer 120 that can be used within the system 100, for example, as a Customer Feedback Reward Server 20, or as a client computer (e.g., such as a desktop computer 14 or mobile computing device 12 (FIG. 1)). For purposes of this disclosure, reference to a server or processor, should be interpreted to include either a single server, a single processor, or multiple servers, or multiple processors.

In particular embodiments, the Computer 120 may be connected (e.g., networked) to other computers by a WAN, LAN, an intranet, an extranet, and/or the Internet. The Computer 120 may operate in the capacity of a server or a client computer in a client-server network environment, or as a peer computer in a peer-to-peer (or distributed) network environment. The Computer 120 may be a personal computer (PC), tablet PC, mobile device, a web appliance, a server, a network router, a switch or bridge, or any computer capable of executing a set of instructions (sequential or otherwise) that specify actions to be taken by that computer. Further, while only a single computer is illustrated, the term “computer” may also include any collection of computers that individually or jointly execute a set (or multiple sets) of instructions to perform any one or more of the methodologies discussed herein.

An exemplary Computer 120 may include a Processor 202, Main Memory 204 (e.g., read-only memory (ROM), flash memory, dynamic random access memory (DRAM) such as synchronous DRAM (SDRAM) or Rambus DRAM (RDRAM), etc.), Static Memory 206 (e.g., flash memory, static random access memory (SRAM), etc.), and a Data Storage Device 218, which communicate with each other via a Bus 232.

The Processor 202 may represent one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The Processor 202 may also be one or more special-purpose processing devices such as an application specific integrated circuit (ASIC), a field programmable gate array (FPGA), a digital signal processor (DSP), a network processor, or the like. The Processor 202 may be configured to execute Processing Logic 226 for performing various operations and steps discussed herein.

The Computer 120 may further include a Network Interface Device 208. The Computer 120 also may include a video display 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

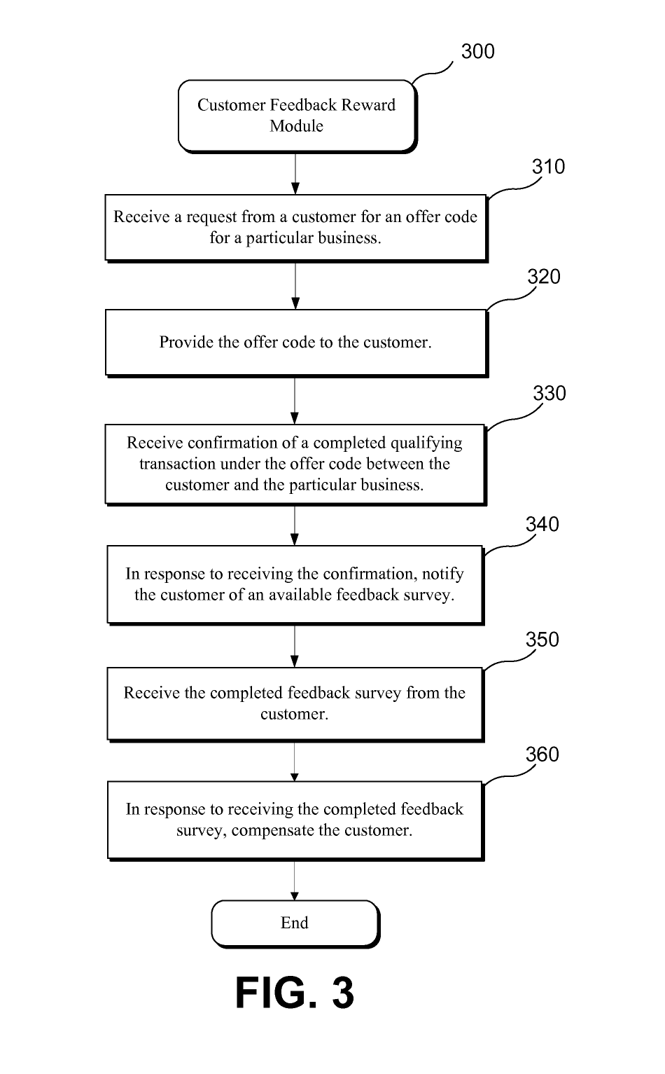

The Data Storage Device 218 may include a machine accessible storage medium 230 (also known as a non-transitory computer-accessible storage medium, a non-transitory computer-readable storage medium, or a non-transitory computer-readable medium) on which is stored one or more sets of instructions (e.g., such as the Customer Feedback Reward Module 300 illustrated in FIG. 3) embodying any one or more of the methodologies or functions described herein. The Customer Feedback Reward Module 300 may also reside, completely or at least partially, within the main memory 204 and/or within the processing device 202 during execution thereof by the Computer 120. Instructions (e.g., such as the Document Storage Module 300) may further be transmitted or received over a network 115 via a network interface device 208.

While the machine-accessible storage medium 230 is shown in an exemplary embodiment to be a single medium, the term “machine-accessible storage medium” should be understood to include a single medium or multiple media (e.g., a centralized or distributed database, and/or associated caches and servers) that store the one or more sets of instructions. The term “machine-accessible storage medium” should also be understood to include any medium that is capable of storing, encoding, or carrying a set of instructions for execution by the computer and that cause the computer to perform any one or more of the methodologies of the present invention. The term “computer-accessible storage medium” should accordingly be understood to include, but not be limited to, solid-state memories, optical, and magnetic media.

### Exemplary System Platform

Various aspects of the system's functionality may be executed by certain system modules, including the Document Storage Module 300. This module is discussed in greater detail below.

Exemplary Customer Feedback Reward Module

FIG. 3 shows a flow chart of operations performed by an exemplary Customer Feedback Reward Module 300. As may be understood from this figure, in various embodiments, the Customer Feedback Reward Module 300 is adapted to provide customers with rewards for completing feedback surveys following transactions at various businesses. For example, the system may be configured to compensate customers who redeem a particular offer code while patronizing a particular establishment if the customer completes a survey about their experience at the establishment.

Beginning at Step 310, the system receives a request from a customer for an offer code for a particular business. The customer may, for example, request an offer code from a list of available offer codes being offered by various businesses. In particular embodiments, the system is configured to receive offer codes provided by particular businesses which customers may then request. In various embodiments, these offer codes may, for example, include offers for discounts on goods or services purchased at the particular business (e.g., offers for 10%, 20%, or 50% off of goods and services offered by the particular business). In other embodiments, the offer codes may provide a discount on goods or services purchased at the particular business that is capped at a particular dollar amount (e.g., the offer code may include an offer for 10% off of a purchase, but have a maximum rebate of $50). In particular embodiments, the customer may access the list of available offer codes via the Internet using any suitable computing device (e.g., a desktop computer, or a mobile computing device such as a laptop computer, tablet computer, or smart phone). In other embodiments, the customer may access a list of available offer codes from which to request an offer code in any other suitable manner.

In various embodiments, the offer codes may entitle the customer to a certain reward or cash incentive for patronizing a particular establishment. For example, an offer code for a pizza restaurant may entitle a customer to a reward of 20% off the amount they spend at the pizza restaurant. In particular embodiments, the particular businesses may elect to participate in the offer code program and may designate what sort of offer codes to offer in association with goods or services that the particular business provides. For example, one pizza restaurant may offer 20% of the amount the customer spends as a reward, while a second pizza restaurant may offer a 10% reward. In other embodiments, offer codes may entitled the customer to a cash rebate in exchange for spending a particular amount of money at the particular business (e.g., $5 off a purchase of $50 or more). In other embodiments, offer codes may comprise any other offer (e.g., an offer which may entice customers to patronize the particular business) such as an offer for a coupon for a future visit to the particular business, an offer for reward credits that may be redeemed at the particular business or other participating businesses, etc.

In particular embodiments, the system may be configured to limit the number of customers who may request a particular offer code. For example, a particular business making an offer code available may limit the offer code to only a particular number of customers (e.g., 20 customers). In other embodiments, the system may be configured to limit the number of times or frequency that a customer may request a particular offer code. For example, the system may be configured to allow the same customer to request a particular offer code no more than once per month.

Returning to Step 320, the system continues by, in response to receiving the request at Step 310 (e.g., at least partially in response to receiving the request), providing the requested offer code to the customer. In particular embodiments, the system may provide the offer code via a short message service (e.g., via a text message). In other embodiments, the system may provide the customer with the offer code by associating the code with an account associated with the user from which the user may access the code at a time when the user wishes to redeem the code. In still other embodiments, the system may provide the code to the customer using any other suitable method (e.g., via electronic mail, via a printable coupon, by displaying the code to the customer and allowing the customer to record or write down the code, etc.).

The system then, at Step 330, receives confirmation of the completion of a qualifying transaction under the offer code between the customer and the particular business. The system may, for example, receive confirmation that a customer has used an offer code while purchasing dinner at a particular pizza restaurant. In various embodiments, the system receives confirmation of the completed qualifying transaction from the particular business (e.g., when the particular business confirms that the offer code has been redeemed). In other embodiments, the system is configured to substantially automatically (e.g., automatically) receive confirmation of a qualifying transaction when the offer code is used during the transaction. For example, as part of the transaction, an employee of the particular business may enter the offer code into the system, or may scan a machine readable indicia (e.g., such as a barcode) associated with the offer code (e.g., from a printed offer code coupon, from a screen of a mobile device associated with the customer, etc.).

In various embodiments, at the time of the qualifying transaction, the customer may pay full price for whatever goods and services the customer purchases from the particular business. In such embodiments, the price paid by the customer at the time of the qualifying transaction is not based on any terms or conditions associated with the offer code.

The system continues, at Step 340, by notifying the customer of an available feedback survey. In various embodiments, the system is configured to notify the customer of the available feedback survey, for example, via a short message service (e.g., via text message), via e-mail, or via any other suitable means of communication. In particular embodiments, notifying the customer of the available feedback survey may include providing the feedback survey to the customer. The feedback survey, according to particular embodiments, may include, for example, questions relating to the customer's experience at the particular establishment. In various embodiments, the feedback survey may include questions that require the customer to provide a satisfaction rating (e.g., a rating from 1 to 5, a rating describing the customer's satisfaction level, etc.). In other embodiments, the feedback survey may require the customer to provide written feedback about various aspects of their experience.

In various embodiments, feedback surveys may include feedback questions based on a type of the particular business (e.g., restaurant, gas station, department store, etc.). Various categories for which a feedback survey may request a customer to rate the particular business may include, in particular embodiments, overall satisfaction, value, service, parking & accessibility, cleanliness, atmosphere, portion sizes, selection, quality, and any other rating categories which may be useful for businesses or customers.

In particular embodiments, the system is configured to allow customers to provide feedback that is directed towards a particular business that may include more than one category or type of business. For example, the system may be configured to allow customers to select a category associated with the purchase experience the customer had at a particular business (e.g., associated with a transaction that occurred between the customer and the particular business). For example, a bowling alley may also include a bar that serves food and drinks Various customers of the bowling alley on a particular visit may patronize the bowling alley and only bowl, other customers may bowl and order food and/or drinks from the bar, while other customers may only patronize the bar in the bowling alley without doing any bowling. For such businesses, the system may be configured to provide feedback surveys that allow customers to assign different ratings for different aspects of the business. In the bowling alley example, a customer may be able to give the bowling alley a high rating for quality (e.g., if they enjoyed bowling there) while assigning a low rating to the bar (e.g., if the food is not particularly good, service was slow, etc.).

Returning to Step 350, the system continues by receiving the completed feedback survey from the customer. In various embodiments, receiving the completed survey includes receiving data corresponding to the customer's responses to one or more questions contained in the survey. In other embodiments, the system receives the completed survey when the customer selects (e.g., clicks on) a “Submit Survey” or similar indicia after completing the survey on a computing device. In various embodiments, the system may be configured to receive the completed feedback survey in any other suitable manner (e.g., by receiving a scan of a completed paper survey, etc.). In particular embodiments, the system may be adapted to allow the customer a particular amount of time such as a certain number of days to complete the survey.

In response to receiving the completed survey from the customer, the system continues, at Step 360, by compensating the customer. In particular embodiments, the system compensates the customer by providing reward credits (e.g., as a code via text message) that the customer may redeem at one or more participating establishments or for items in a rewards database. In other embodiments, the compensation may be in the form of reward credits that are sent directly to a customer rewards account associated with the customer. In further embodiments, compensation may be in the form of cash that is added to an account associated with the customer (e.g., a bank account such as a checking or savings account). In various embodiments, the compensation is based on terms and conditions associated with the offer code. In other embodiments, the value of the compensation is based at least in part on a value of any purchases made as part of the completed qualifying transaction.

In various embodiments, the system may be configured to withhold compensation that the customer may be entitled to under the offer code if the customer fails to complete the feedback survey. In embodiments in which the system provides a deadline by which the customer must complete the feedback survey, the system may be configured to not compensate the customer upon determining that the customer has not completed the feedback survey by the deadline. For example, because at the time of the qualifying transaction the customer pays full price for any goods and services purchased, any reward or discount to which the customer would be entitled under the offer code would not have to be paid to the customer if the customer failed to complete the required survey. In such embodiments, the particular business may still have benefited from the customer having patronized the business to redeem the offer code without having to provide any compensation to the customer.

### Illustrative Example of Use of a Customer Feedback Reward System

A customer wishing to utilize offer codes to particular businesses may search through an offer code database for available offer codes. For example, the customer may search through available offer codes using a mobile computing device such as the mobile computing device 12 in FIG. 1 to access an application that contains a listing of available offer codes. The offer code database may be accessible via, for example, any suitable computing device (e.g., a tablet computer, a desktop computer, a laptop, or a smartphone). As a particular example, if the customer is searching for an offer code for a sushi restaurant, the customer may search the offer code database for participating sushi restaurants. When the customer locates an offer code that is appealing, the customer may select the offer code, and the system, at Step 310, will receive the request for the offer code. Next, at Step 320, the system may provide the offer code to the customer for the particular business. In this example, the system would provide the customer with the offer code for the sushi restaurant that the customer selected. The offer code may, for example, entitle the customer to a reward in the amount of 20% of the customer's next purchase at the sushi restaurant. The system may send the offer code to the customer, for example, via a text message, display the code on the customer's mobile computing device 12, or send the code using any other suitable communications mechanism, such as email.

The customer then visits the sushi restaurant, purchases sushi at regular price, and presents the offer code to a representative of the restaurant. The restaurant then sends a notification to the system (e.g., an employee of the restaurant uses a mobile computing device to notify the system) that the customer completed a qualifying transaction under the offer code at the sushi restaurant. Next, at Step 330, the system receives the notification. The system then notifies the customer, at Step 340, of an available customer feedback survey for the sushi restaurant. The feedback survey may include, for example, questions relating to the cleanliness of the restaurant, the quality of the food, or any other questions related to the customer's experience at the restaurant. The customer then completes the feedback survey (which may be, for example, an on-line survey) and submits the completed survey to the system.

Once the system receives the completed feedback survey from the customer at Step 350, the system sends compensation to the customer at Step 360. In this example, the system adds reward credits to the customer's account in an amount that is equal to 20% of the amount that the customer spent at the sushi restaurant. The customer may then redeem the reward credits from a rewards database.

### Exemplary User Interface

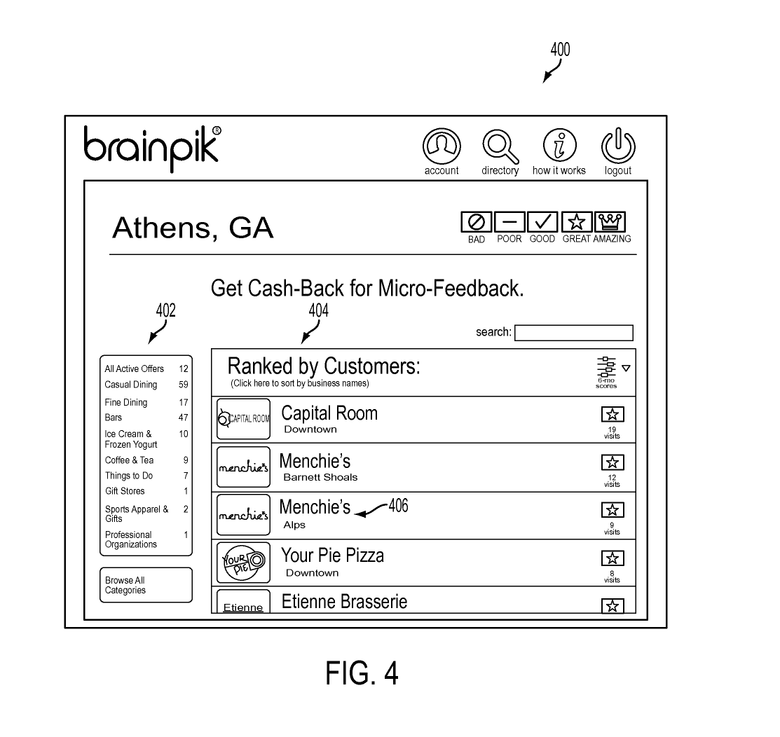

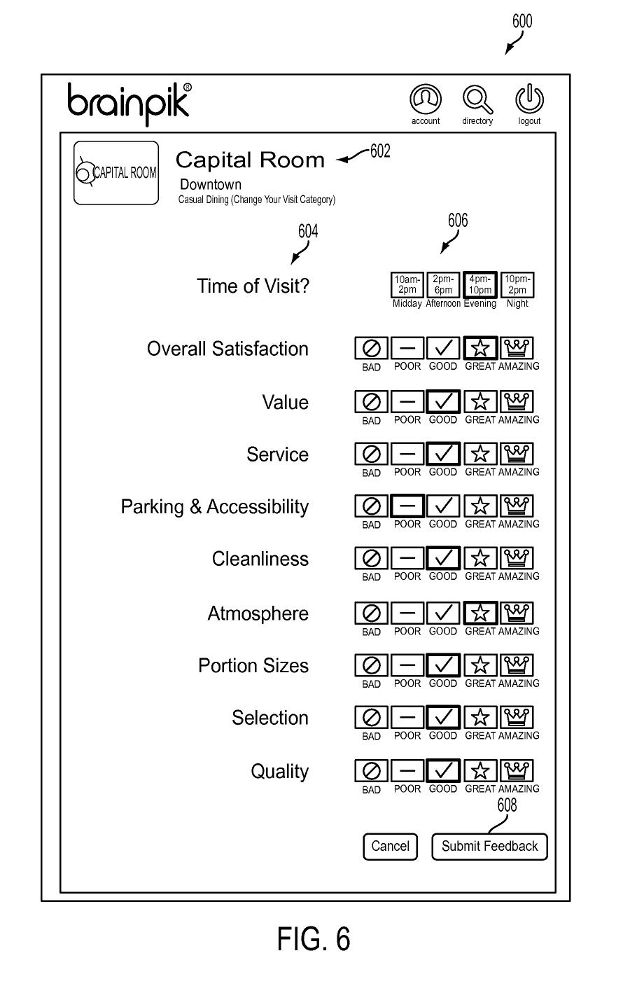

FIGS. 4-6 show exemplary user interfaces for a particular embodiment of a Customer Feedback Reward System. The user interfaces shown in these figures may include interfaces displayed on any suitable computing device (e.g., a tablet computer, desktop computer, laptop computer, or smart phone). These interfaces may, for example, be used by users to browse available offer codes, receive codes that the user finds compelling, complete feedback surveys, and redeem reward credits.

FIG. 4 shows an exemplary user interface 400 from which a user may view a list of particular businesses 404 for which offer codes are currently available. As may be understood from this figure, the businesses with available offers are listed according to ranking (e.g., based at least in part on previously completed customer feedback surveys). In various embodiments, the system may be configured to allow customers to browse a complete listing of businesses 404 according to ranking as shown—in other embodiments, the system may be configured to allow customers to view businesses in any other suitable manner (e.g., by name, by type of business, etc.).

As shown in this figure, the system may be configured to allow customers to select categories of businesses 402 to browse for available offers or to view reviews from other customers. These categories may include, for example, Casual Dining, Fine Dining, Bars, Ice Cream & Frozen Yogurt, Coffee & Tea, Things to Do, Gift Stores, Sports Apparel & Gifts, Professional Organizations, or any other category within which it may be useful for customers to browse for various businesses. The system may be configured to allow customers to select a particular business 406 to view available offers associated with that particular business.

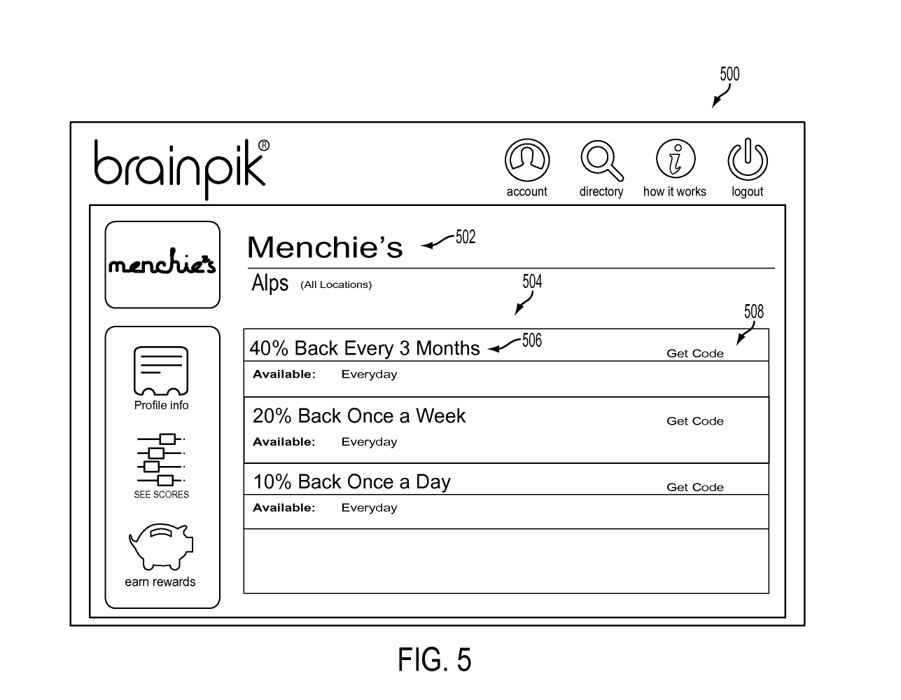

FIG. 5 shows an exemplary user interface 500 that includes available offers for a particular frozen yogurt business 502. As may be understood from this figure, the system is configured to display available offers 504 from which a user may select an offer code. As shown in this figure, offers may be limited by the frequency with which a user may claim an associated offer code (e.g., every 3 months, once a week, etc.). A user wishing to claim a particular offer 506 may select (e.g., click on) a “Get Code” indicia 508 associated with the particular offer 506. In response to selection of the Get Code indicia 508 by the customer, the system may be configured to provide a code for the associated particular offer 506 to the customer (e.g., via text message).

Figure six shows an exemplary feedback survey 600 that the system may provide to a customer in response to receiving confirmation of a completed qualifying transaction between the customer and a particular business under an offer code. As shown in this figure, the feedback survey 600 includes the name of the particular business 602 as well as rating categories 604 and associated rating indicators 606 for the particular business. In particular embodiments, rating categories may include, for example, Overall Satisfaction, Value, Service, Parking & Accessibility, Cleanliness, Atmosphere, Portion Sizes, Selection, Quality, and any other rating categories which may be useful for businesses or customers. Rating categories, in various embodiments, may be based on a type of business for which the feedback survey has been compiled (e.g., restaurants may contain more rating categories for cleanliness, food quality, etc.). Each rating category 604, in particular embodiments, may have an associated rating indicator 606, with which a customer may select an appropriate rating (e.g., based on the customer's experience at the particular business). Ratings may include, for example, ‘Bad’, ‘Poor’, ‘Good’, ‘Great’, ‘and ‘Amazing’. In other embodiments, ratings may include numerical ratings (e.g., from 1-10) or any other suitable rating system. After selecting ratings for the various rating categories 604, the user may select a Submit Feedback indicia 608. In response to selection of the indicia, the system may be configured to provide the customer's feedback to the particular business and compensate the customer (e.g., via suitable paper or electronic communications).

### Alternative Embodiments

Alternative embodiments of a Customer Reward Feedback System may comprise features that are, in some respects, similar to the features described above in addition to some distinguishing features. For example, in particular embodiments, the system may be adapted to allow businesses to rate customers. Businesses may be able to rate customers, for example, based on how much money the customer spends or how frequently the customer patronizes the business. In particular embodiments, the system is configured to allow businesses to rate customers on other factors such as, for example, whether a customer complained or was rude, whether the customer was messy, whether the customer was a good tipper, etc. In various embodiments, customer ratings may allow businesses to create targeted offer codes or deals for certain types of customers (e.g., to reward good customers or to provide extra incentive for bad customers).

In particular embodiments of the system, the feedback surveys may include a rating scale that includes both positive and negative numbers. For example, a feedback survey may include a rating scale from negative five to positive five. Such a rating scale may be adapted to allow a user to assign a rating of a positive number for businesses that the customer finds to be above average, a negative number for businesses that the customer finds to be below average, or a zero rating for businesses that the user finds to be average.

In various embodiments, the system may be configured to make an offer code that had been provided to a particular customer available to other customers after a particular amount of time has elapsed without the particular customer having made a qualifying transaction under the offer code. For example, the system may be configured to make the offer code available for another customer to request if the particular customer that had originally claimed the offer code had not made a qualifying transaction within one week.

In particular embodiments, the offer code may include a promise by the particular business to make a donation to a charity or similar charitable organization rather than providing compensation to the customer directly. In such embodiments, the customer may select the charity, or the particular business may select a charity to which they would make a donation.

In various embodiments, the system may be configured to associate each customer that uses the system with the customer's mobile phone number. In such embodiments, the system, when providing offer codes to a customer, may associate the offer code with the customer's mobile phone number. In such embodiments, the system may be further configured to track a customer's offer code redemption based on the customer's mobile phone number. In various embodiments, the system may be configured to require customers to register a valid mobile phone number before receiving offer codes (e.g., to limit the frequency with which a particular customer may redeem specific offers).

In particular embodiments, the system may not include all of the components described above, or may include combinations of the described components. For example, in particular embodiments, Rewards and Offer codes may be contained within a single database rather than separate databases. In various embodiments, the system may require only the use of a wireless device (e.g., a smartphone) to access the various features of the system.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system comprising at least one processor, wherein said computer system is configured for:
receiving, from a customer, a request for an offer code associated with a particular business;
providing said offer code to said customer;
receiving confirmation of a completed qualifying transaction under said offer code between said customer and said particular business;
in response to receiving said confirmation, notifying said customer of an available feedback survey for said particular business;
receiving a completed version of said feedback survey from said customer; and
in response to receiving said completed version of said feedback survey, providing compensation to said customer.

2. The computer system of claim 1, wherein said compensation is based at least in part on terms and conditions associated with said offer code.

3. The computer system of claim 2, wherein said providing said offer code to said customer comprises sending said offer code to said customer via one or more short message services.

4. The computer system of claim 1, wherein said compensation is based at least in part on a price of said qualifying transaction.

5. The computer system of claim 1, wherein:
said completed qualifying transaction comprises a purchase price, said purchase price being paid by said customer to said particular business; and
said purchase price is not based on one or more terms associated with said offer code.

6. The computer system of claim 5, wherein said compensation is based at least in part on said one or more terms associated with said offer code.

7. The computer system of claim 1, wherein:
said completed qualifying transaction comprises a purchase price;
said offer code is associated with one or more terms that comprise a rebate on said purchase price; and
said compensation is based at least in part on said purchase price and said rebate.

8. The computer system of claim 1, wherein said offer code comprises an offer for one or more rewards to said customer in exchange for completing a qualifying transaction with said particular business and competing said feedback survey.

9. The computer system of claim 8, wherein:
said available feedback survey comprises a period of time; and
said computer system is further configured for:
determining a notification time at which said customer was notified of said available feedback survey; and
in response to determining that said period of time has elapsed since said notification time without said customer having completed said available feedback survey, not providing said compensation to said customer.

10. The computer system of claim 1, wherein said compensation comprises one or more reward credits.

11. The computer system of claim 10, wherein said computer system is further configured for:
providing, to said customer, a rewards database comprising one or more rewards; and
enabling said customer to redeem said one or more reward credits in exchange for said one or more rewards.

12. A non-transitory computer-readable medium storing computer-executable instructions for:
(A) receiving from a customer, a request for an offer code associated with a particular business, said offer code comprising an offer associated with one or more goods or services offered by said particular business;
(B) providing said offer code to said customer;
(C) receiving confirmation of a purchase of said one or more goods or services by said customer from said particular business, said one or more goods or services having a particular price;
(D) notifying said customer of an available feedback survey for said particular business;
(E) receiving a completed version of said feedback survey from said customer; and
(F) in response to receiving said completed version of said feedback survey, providing compensation to said customer.

13. The non-transitory computer-readable medium of claim 12, wherein said offer associated with said one or more goods or services is an offer for a discounted price on said one or more goods or services based at least in part on said particular price.

14. The non-transitory computer-readable medium of claim 13, wherein said compensation is based at least in part on said discounted price and said particular price.

15. The non-transitory computer-readable of claim 12, wherein said feedback survey is based at least in part on an experience of said customer at said particular business during said purchase of said one or more goods.

16. The non-transitory computer-readable medium of claim 15, wherein said feedback survey comprises a request for feedback associated with said particular business for at least one category selected from a group consisting of:
(A) value;
(B) service;
(C) cleanliness;
(D) accessibility; and
(E) quality.

17. A computer system comprising at least one processor, wherein said computer system is configured for:
receiving, from a customer, a request for an offer code associated with a particular business, said offer code being associated with an offer for compensation in exchange for completion of one or more feedback surveys by said customer;
providing said offer code to said customer;
receiving confirmation of a transaction between said customer and said particular business, said transaction comprising:
a purchase by said customer of one or more goods, one or more services, or one or more goods and one or more services from said particular business, said purchase having a price that does not depend on said offer; and
provision of said offer code by said customer to said particular business;
in response to receiving said confirmation, providing said one or more feedback surveys to said customer;
receiving confirmation of completion of said one or more feedback surveys by said customer; and
in response to receiving said confirmation of said completion of said one or more feedback surveys, providing said compensation to said customer.

18. The computer system of claim 17, wherein said compensation is based at least in part on said price.

19. The computer system of claim 17, wherein said one or more feedback surveys are based at least in part on an experience of said customer at said particular business during said transaction.

20. The computer system of claim 19, wherein:
said compensation comprises one or more reward credits; and
said computer system is further configured for:
providing, to said customer, a rewards database comprising one or more rewards; and
enabling said customer to redeem said one or more reward credits in exchange for said one or more rewards.

21. The computer system of claim 17, wherein:
said computer system is further configured for enabling said customer to select one or more categories associated with said transaction; and
said one or more feedback surveys are based at least in part on said one or more categories.
